(19) United States
(12) Patent Application Publication
(10) Pub. No.: US 2017/0144476 A1
(43) Pub. Date: May 25, 2017

(54) DIGITALLY PRINTED COLOR SWATCHES WITH TEXTURED EFFECT

(71) Applicant: SUN CHEMICAL CORPORATION, Parsippany, NJ (US)

(72) Inventors: Stephen Roderick POSTLE, Glen Rock, NJ (US); Danny RICH, Trenton, NJ (US)

(73) Assignee: SUN CHEMICAL CORPORATION, Parsippany, NJ (US)

(21) Appl. No.: 15/327,068

(22) PCT Filed: Jul. 22, 2015
(86) PCT No.: PCT/US2015/041457

§ 371 Date: Jan. 18, 2017

Related U.S. Application Data
(60) Provisional application No. 62/027,400, filed on Jul. 22, 2014.

(51) Int. Cl. B44D 3/00; B41M 3/00; B41M 3/06; B41M 3/16; B41M 5/00; B41M 5/395; B41J 2/02; B41J 2/04; B41J 2/325; B41M 7/00; B41M 5/382

(52) U.S. Cl. CPC B44D 3/003; B41M 7/0081; B41M 3/008; B41M 3/06; B41M 3/16; B41M 5/38264; B41M 5/395; B41J 2/02; B41J 2/04; B41J 2/325; B41M 5/0064; B41M 5/0047; B41M 5/0052; B41M 2205/02; B41M 2205/34

(57) ABSTRACT

The present invention provides a method for the production of textured color selection swatches for point of purchase displays of custom blended paints, for color selection guides of dyed or printed textiles or for color selection extruded chips of custom colored plastics using a digital inkjet printer and custom blended inkjet inks based on a set of base inks that can be blended using commercial match prediction software and wherein a textured effect is applied as a component of the color selection aids. The textured effect may be achieved either by printing in three dimensions or printing a pseudo-three dimensional effect.

### CROSS REFERENCE TO RELATED APPLICATIONS

This application claims priority to U.S. Provisional Patent Application Ser. No. 62/027,400 filed Jul. 22, 2014, which is hereby incorporated herein by reference in its entirety and for all purposes.

### FIELD OF THE INVENTION

The present invention is directed to providing textured custom colored swatches having a custom colored ink layer in combination with a texturing composition layer and a method of producing custom color inks which can be printed above and/or below the texturing composition layer. The present invention further relates to a method for matching the custom color inks to one or more desired reference colors, and using the custom color inks to print a custom colored ink layer on a substrate having a printed or coated layer thereon providing a desired texture. The resultant swatch produces both a desired color and a desired texture and thus provides a complete appearance match.

### BACKGROUND OF THE INVENTION

Many colors, and variations thereof, based on lightness, hue, and saturation within a certain color family exist. Many products are manufactured that are colored in very specific ways, such as architectural coatings (i.e. paints), cosmetics, and the like. Standard color matching systems are published by Pantone and Sun Chemical Printing Inks. It is often desirable to present the full selection of colors in a visual display. Because of the many colors that may be available, it is challenging to create a display that is easy to understand, and from which a customer may choose. Manufacturers often use color sample cards, or textile swatches, or color charts to present the range of colors, and all of their variations. The arrangement of these color sample cards, textile swatches, and color charts is essential to creating a pleasing visual display.

Currently, color sample swatches are typically produced by blade coating a wide roll of paper, fabric, card or plastic film, air drying the coated paper, fabric, card or plastic film, rolling the paper, fabric, card or plastic film up, and then taking the roll of paper fabric, card or plastic film to a printing system, such as a web-offset press, in order to print onto the substrate labels, identifiers, trademarks and such in a second printing step, so that consumers can identify the color that is selected by the store technician who will then request the formula from the recipe database. If anything goes wrong, the whole process must be repeated. Therefore, there is a need for a more efficient process to produce the color sample swatches.

Swatches used in the paint industry typically use custom colored cards, whilst swatches used in the textile industry typically use pieces of cloth mounted to a card or thread wound around a card. Finally swatches used in the plastics industry usually employ extruded chips of plastic to show both color and texture. However each of these requires producing the textured color and then manually mounting them onto a pre-labeled card.

Moreover, it has typically been a challenge to accurately re-produce the range of colors available for a product, such as a paint, onto, for example, color sample cards. Various methods of printing custom-colors have been developed in an attempt to re-produce the full range of colors, wherein the colors closely match the actual product colors.

Typically, custom colors have been printed by halftone printing, wherein the desired color is achieved by overprinting different amounts of the primary colors in a set, such as the cyan, magenta, yellow and black (CMYK) cartridges found in standard ink jet printers. However, the number of custom colors that can be produced in this way is limited by the number of primary colors that are used. Despite advances, the halftone process is severely limited in terms of accuracy of the output color, registration of color, non-uniformity of the color, blurring, color variances, etc.

Furthermore the number of custom colors that can be produced in this way is limited by the number of primary colors that are used. Moreover, the level of metamerism between the desired color and the process printed color is often too great and thus the swatch will have a vastly different appearance in the store and in the home.

US 2005/0160641A1 discloses sample displays which display both colors and textures in the form of a fan deck, whilst U.S. Pat. No. 2,179,767A also discloses swatches having different colors on different cloth.

US 20050064338 A1 discloses a means to reproduce for quality control purposes the true color of naturally-colored objects to be printed e.g. wood-grain by using a randomized dot structure to print a multicolor set of inks.

U.S. Pat. No. 6,270,123 discloses a color identification and selection display, based on lightness values or levels, for use in connection with the retail sale of custom-tinted architectural coatings and paints.

U.S. Pat. Nos. 7,502,033 and 8,089,482 disclose a computer display of color elements that is grouped within a plurality of color families which are organized in accordance with a circular color chart and a columnar chart.

U.S. Pat. No. 7,999,825 discloses a computer-based color selection system. The colors in the database are arranged based on color theory.

U.S. Patent Application No. 2004/0046803 discloses a computer-based color selection system. A plurality of colors are categorized into one of a plurality of color groups, to which a reference color can be matched.

U.S. Patent Application No. 2005/0146531 discloses a paint color matching and coordinating system which chooses harmonious sets of paint colors based on an input reference color.

U.S. Patent Application No. 2006/0203245 discloses a color card wherein a light color tone occupies a larger space than the darker color tones on a color card.

U.S. Patent Application No. 2008/0026347 discloses a kit that can be used to create and select paint colors, containing at least one base color paint, several containers of colored tints, and a booklet with coordinated matching sheets and self-adhesive stickers.

U.S. Patent Application No. 2010/0169255 discloses a searchable database for finding a paint color having a desired texture. Methods for using the database are also disclosed.

U.S. Pat. No. 6,938,984 discloses an inkjet printing system apparatus, wherein a custom color is produced by mixing multiple colored inks blended in pre-selected combinations, and printing a solid image pattern, rather than multiple halftone image patterns.

U.S. Pat. No. 7,258,407 discloses dispensing two primary color inks into a custom color chamber, mixing the inks, and printing the custom color ink from the custom color chamber with a print head.

U.S. Pat. Nos. 7,259,890 and 7,551,321 disclose the use of a printing device that has several cartridges, such as cyan, yellow, magenta, and black (CYMK), plus a custom cartridge containing a non-standard colorant material. Each cartridge has an e-label (memory storage element) that identifies the ink contained in that cartridge.

U.S. Pat. No. 7,942,488 discloses a custom color print head capable of mixing custom color inks for an imaging device, by combining inks from a pre-loaded set of color ink sticks.

U.S. Pat. No. 8,282,197 discloses an inkjet printing method wherein two or more color inkjet inks having the same color and color density, but different compositions, are mixed, and then printed.

WO 2008/045352 discloses custom printed retail paint merchandizing aids, such as color cards, having one or more color schemes displayed in predetermined fields for use in selecting custom-mixed architectural coating colors. The cards are printed using inkjet inks that are formulated with the same pigment dispersions as the architectural coatings, and are thus limited only to those particular pigment dispersions, which are generally aqueous. In addition, the pigment dispersions may not be well-suited for the requirements for inkjet inks. WO 2008/045352 further discloses that the texture (i.e. gloss, matte, etc.) can be reproduced by choosing particular substrates. However, the inks are printed in the conventional manner, and therefore utilize the limited halftone printing process. As such, overprinted colors will not necessarily attain the texture properties of the substrate.

U.S. Pat. No. 6,644,763 and US-2009/0155483 disclose inkjet printing methods for creating raised effects by applying a light curable adhesive or an ink on to a substrate.

EP 1 676 715 A1 discloses a data carrier with a tactile feature applied by an inkjet printing process wherein the tactile feature may contain dyes or pigments so as to allow visual inspection and/or automated inspection.

WO 2010/071993 discloses a method for making tactile patterns on a substrate by screen printing or inkjet printing a UV-curable deposit material onto the substrate.

PantoneLIVE™ is a digital color palette library developed by Panton, Sun Chemical and Esko. Each color is associated with a spectral signature in terms of lightness, red/green value, and yellow/blue value. Using the reference color spectral data, custom spot color inks matching the reference colors can be developed using the InkFormulation Software (IFS) technology. Using IFS, an appropriate ink formulation is predicted, so that the printed color will match the Panton® reference color. Currently, PantoneLIVE™ and other color selection systems are used by printers/converters for press printing. There is currently no way to use the PantoneLIVE™ digital library, or other systems, to formulate inkjet inks to match the reference colors.

Currently, commercial producers of house paints invest up to many millions of dollars annually in the production of marketing aids. Thus, there is a need for an efficient custom color printing system that can accurately reproduce and show a range of custom colors on various textured substrates.

### SUMMARY OF THE INVENTION

The present invention provides a method for producing a textured custom color swatch comprising printing or coating at least one custom color ink layer and at least one texturing composition layer onto a substrate.

Furthermore the present invention also provides a textured colored swatch card, palette or display produced using the method of the invention.

These and other objects, advantages, and features of the invention will become apparent to those persons skilled in the art upon reading the details of the methods and formulations as more fully described below.

### BRIEF DESCRIPTION OF THE DRAWINGS

FIG. 1 shows the surface profile of textured custom colored swatches according to the present invention.

### DETAILED DESCRIPTION OF THE INVENTION

Colored textured swatches have been previously produced by providing a colored ink layer on a specialized pre-textured substrate which is expensive and limited to one form of texture.

It has now been found that a textured custom color swatch can be produced by printing or coating at least one custom color ink layer and at least one texturing composition layer onto a standard substrate which allows many different colored texture types to be produced.

The texturing composition layer is defined as the composition layer that provides the textured effect which can be an actual three dimensional printed or coated effect or a pseudo three dimensional effect, such as marbling, embossed and hammer-finish created via the interaction between the texturing composition and the custom color ink.

The present invention also provides an ability to digitally select and print a plurality of textured custom colored swatches on standard substrates.

The substrates typically include but are not limited to fibrous materials such as paper, card and wood, plastics and polymers such as films and chips and fabric and textiles. Furthermore the substrates may also include laminates and composites of such materials e.g. polyethythene laminated paper.

A preferred embodiment of the invention provides a method for the production of color selection swatch cards for point of purchase displays of custom blended paints, for color selection guides of dyed or printed textiles or for color selection extruded chips of custom colored plastics using a digital inkjet printer and custom blended inkjet inks based on a set of base inks that can be blended using commercial match prediction software, wherein a textured appearance is printed or coated as a component of said color selection aids. The base inks are matched spectrally to the base paints, dyes or plastics.

In one embodiment the present invention provides a method for digitally printing a textured custom color swatch comprising
a. producing a custom color ink that is a spectral match to a desired color by blending inkjet base inks with transparent, translucent or opaque white bases to produce colors;
b. printing the custom color ink onto a substrate or a texturing composition layer using an inkjet printer to provide a printed custom color ink layer and
c. printing or coating a texturing composition layer onto the substrate, either before printing, after printing or both before and after printing the custom color ink layer to provide the textured custom color swatch.

The texturing composition typically contains a texturing additive.

The texturing additive may include waxes such as polyethylene, carnauba, lanolin, beeswax and tallow, polytetrafluoroethylene (PTFE) powder, PTFE/polyethylene wax mixtures and/or PTFE/talc mixtures.

The texturing additive may also include nylon, ceramic materials, inorganic pigments, rubber, alumina, silicon carbide and/or perlite.

The texturing additives may further include hollow glass microspheres, plastic beads, for example polystyrene, voided plastic microspheres, for example polymethyl methacrylate, silica, baryta, clays, zinc oxide, starches, clays, calcium carbonate and other fillers; micaceous, pearlescent and other optically variable pigments.

Furthermore the texturing additives may also include foamable inks or coatings, resins, polymers, microlenses and opaque and/or translucent inorganic and/or organic pigments.

In particular, a textured effect could be provided by including particulate matter in an ink jet ink, or by ink jetting two incompatible resins, from two different ink jet heads, so that when they mix, they flocculate and produce some texturing (or, similarly, print two reactive chemicals that react on the substrate and produce a non-uniform surface).

Furthermore a texture effect could be provided by repeatedly printing and drying in some areas, so as to build up something akin to Braille.

Advantageously, the texturing composition is printed in a pattern onto the substrate so as to create a layered pattern which provides a raised or a contrasting surface and the custom color ink layer is then printed on top of the texturing composition layer to create the textured effect.

Preferably, the textured effect provides a tactile sensation of texture and advantageously these provide a rough or grooved effect or mimic the textured effect of suede, cement, leather, satin, woven, wood-grain and Braille.

Optionally, the custom colored ink layer and/or the textured composition layer may be cured prior to the subsequent layer being printed or coated thereon.

In a further embodiment of the present invention if the custom colored ink layer is uncured prior to the deposition of the texturing composition layer i.e. “wet-on-wet”, an interaction between the two inks may be used to create a texture effect. Examples of textured effects that may be created in this manner include graininess and marbling.

The interaction of the ink and the composition derives from formulating a custom colored ink and a texturing composition that are partially or completely incompatible. Incompatibility can be designed into the inks and compositions by ensuring their surface tensions are very different, for example, or by formulating them such that they employ incompatible solvent systems which can provide, for example, a marbling effect.

Furthermore a shimmering pseudo three dimensional effect may be produced by printing a texturing composition that contains a substantially transparent pearlescent or optically variable pigment and this is particularly advantageous in producing automotive paint effects.

Additionally a lenticular effect may be produced by providing a texturing composition that comprises micro lenses therein which would result in a reflective texturing effect, whilst a distressed, cracked or hammer finish textured effect may be produced by ensuring either the ink or the composition shrinks in the presence of the other, or by having the ink and the composition interact chemically, producing shrinkage and cracking in the underlying layer.

In one embodiment a cratered or “orange peel” effect may also be produced through ink and composition incompatibility or alternatively by thermally removing solvent from either the ink and/or the composition under controlled conditions, creating bubbles and craters.

Wood-grain and “drag mark” effects may be produced by printing an incompatible texturing composition wet-on-wet over the top of a custom color ink while moving the substrate at a greater speed than the digital print head is printing the custom color ink, or by vibrating some part of the print system so as to introduce imperfections into the printing.

In a yet a further embodiment the present invention provides for the textured effect to be created by sacrificial means, and in particular by removing selected portions of texturing composition layer either, before or after curing, by physical or optical means.

Suitable physical means include deliberate scratching with a stylus or abrasive member, whilst suitable optical means, which burn or ablate a portion of the texturing composition layer, include lasers such as a carbon dioxide or YAG laser.

Those skilled in the art will understand that either means may be employed in an analog fashion, to generate a random texturing or in digital fashion, so as to reproduce a texture selected from a preexisting library of textures stored digitally in a computer, or scanned from an existing object of desired texture.

The texturing composition layer may be printed onto the substrate or the custom color ink layer using offset, lithographic, flexographic, gravure, letterpress, xerography, screen or ink jet printing or coated onto the substrate or the custom color layer using roll, reverse roll, anilox, curtain, slot, cascade, spray, powder and wire-wound bar coating.

However, wherein ink jet printing is used typically a pseudo three dimensional effect is created by using a texturing composition that is incompatible with the custom colored ink such that when they contact each other they flocculate to produce the textured effect.

Similarly, a texturing composition that chemically reacts with the custom colored ink may be used such that upon contact they create a non uniform surface on the substrate.

Alternatively, the texturing composition may be formulated with a very fast solvent such that the composition dries before it can spread cratered textured effect.

The texturing composition layer may be printed both before and after the custom color ink. By this means, a combination of textured effects may be produced, or a single textured effect may be emphasized. The two texturing composition layers need not be the same.

Furthermore the texturing composition layer may be printed more than once, to produce a more obvious or enhanced texture.

The texturing composition may be transparent, translucent, chromatically or achromatically colored, so as to produce the desired effect, both in terms of opacity and in terms of hue, chroma and lightness of the final chip, swatch or card.

The substrate may be printed or coated on both sides and two-sided printing or coating is particularly advantageous in the fabric industry. The two sides can either have the same or different textured effect.

Advantageously alphanumeric information is printed simultaneously when printing the custom color ink layer and this alphanumeric information may typically indicate the swatch color, preferably in conjunction with the textured effect.

Additionally more than one textured effect, preferably printed in a pattern of textured effects can constitute a part of the chip, swatch or card and again this is particularly advantageous in fabrics industry, for example, where a striped satin or checkerboard effect is desired, overall, with separate, contrasting textures within the stripes or squares, respectively.

The present invention also provides a color swatch card, palette or display produced using the method of the present invention, and additionally a means to select a texture, either by scanning an existing texture and using the digital data set corresponding to that scan to reproduce the texture onto the substrate or by selecting a texture from a preformed data set held in a computer. The texture effects available within PowerPoint® manufactured by Microsoft Corporation are but one example of a texture library that could be employed.

In the present invention, different pigments are used in the inkjet base inks and may be matched to the spectral signature of a set of universal dispersions. Thus, metamerism is controlled in a much simpler manner than in traditional color card production systems. In the present invention, the inkjet inks are prepared before jetting and thus only one ink layer is required to produce the desired color. The surface appearance of the color will be modulated by the surface appearance of the substrate, the textured coating or the texturing printing.

In the present invention, any printed text is preferably applied in a single step at the same time that the color swatches are being printed, thus greatly reducing the time and handling from a request for swatches to a finished marketing aid. This also represents energy savings and waste reduction as two distinct printing operations can be condensed into a single print step.

It is well known in the graphic reproduction of packaging markets that UV cured inks are extremely durable against mechanical abrasion or dilution with common household solvents. Thus, it is a preferred embodiment of the present invention that the inkjet inks are energy curable, preferably UV curable. But this is not a requirement and solvent-based and water-based digital inks could also be used.

The general chemistry of the inks used in the method of the present invention is not critical and virtually any materials and formulations that are suitable for use in electron beam (EB) curable inks, UV curable inks, 100% solids inks, hot melt wax inkjet inks, solvent-based and water-based inkjet inks can be used. However, it is not uncommon for the spectral output of finished inks to shift when the chemistry is changed. Thus, when changing the chemistry of the inkjet inks used in the method of the present invention (e.g. from solvent-based to UV curable), it may be necessary to rematch the set of primary inkjet inks to the primary colors in the paint matching system such that the inkjet inks remain a close spectral match to the paint primaries so as to minimize metamerism.

In particular the present invention is directed to a system and method for the production of color selection swatch cards for point of purchase displays of custom blended paints using a digital inkjet printer and custom blended inkjet inks based on a set of base inks that can be blended using commercial match prediction software. The base inks are matched spectrally to the base paints.

In a preferred embodiment, the present invention provides a set of inkjet inks that are spectrally matched to a set of universal dispersions used to color white bases in a point of purchase retail or commercial paint store, a computer-assisted colorant recipe prediction system with a library with the inkjet colorants' optical properties, a computer interfaced inkjet ink dispensing system and preferably a wide format inkjet printer with at least 7 print heads (though inkjet printers with fewer print heads could also be used) and ink supplies. The inkjet inks will preferably be energy curable, though they may also be water-based or solvent based. The image for the prints will preferably be a PDF/X type document (though other imaging systems known in the art could also be used), preferably with variable text and 5 to 7 color patches. Each patch is to be printed using a different print head and colored ink. The identifications and labels will preferably be printed with the last print head and ink, typically black but may be a lighter color if there are dark colored patches on the card.

The present invention describes the production of color matches by blending inkjet ink bases. In the present invention, the inkjet bases are spectrally matched to the universal dispersions, using pigments that are ideally suited to the inkjet medium and to the ink curing process (see description of a “spectral match” below). This will result in inkjet bases that behave optically as if they were produced in the same chemistry as the universal dispersions, without requiring the water borne dispersions. According to the present invention, the digital inkjet press will print the color chips, the labels and interface directly with a laser or knife based stencil cutting machine that will cut apart the strips of chips and stack them for shipping.

One skilled in the art will understand that by “spectral match” is meant that the spectral reflectance factor curve of the inkjet primary color will exhibit a minimum of deviations from the spectral reflectance factor curve of the paint primary color. This minimal spectral deviation can be verified using a metamerism index (MI). If using a special index of metamerism, one that compares the color differences between the inks and the paints for multiple illuminants, at least 3 illuminants are required, a daylight illuminant, an incandescent illuminant and an office light illuminant. These may be, but are not restricted to, CIE standard illuminants, such as D65, A, F2 (typical of cool white fluorescent lamp light) or F11 (typical of a modern high efficiency tri-phosphor fluorescent lamp). If using a general index of metamerism, one that compares the spectral color stimulus functions of the inkjet primaries and the paint primaries, the comparison shall be performed wavelength by wavelength across the visible spectrum (400 nm to 700 nm) at intervals of 10 nm or preferably 5 nm. The spectral color stimulus function is the wavelength by wavelength product of one standard illuminant, such as CIE D65, but it may be other CIE daylight illuminants, with the reflectance factor of the selected primary color. The result will be a series of comparisons (for example 16 or 31) between the inkjet primary reflectance curve and the paint primary reflectance curve, weighted by the CIE standard observer functions, thus emphasizing differences where the human observer is most sensitive and tolerating differences where the human observer has minimal sensitivity to the differences in reflectance factor. The discrete points may be further combined into a single index by taking a sum of squares or sum of the absolute value of the individual differences. If the two primaries are an exact spectral match then the differences and the sums will have the value of zero (0).

The use of a computer assisted color recipe prediction system with a library containing the optical properties of the primary inks and an ink dispensing system is known in the art. One such system is provided in U.S. Pat. Nos. 7,034,960, 7,202,976, 7,268,918, 7,738,149 and 8,233,189, all of which are incorporated by reference.

In the process of the present invention, the colors of a set of paint swatches are preferably submitted to the colorant recipe prediction software in the form of a spectral reflectance factor table, though virtually any other known methods of color matching could be used, including manual color matching. A predicted formula for each color is produced and proofed. If the proofed color is within the tolerances on total color differences (ΔE) and on metamerism (MI) supplied by the paint manufacturer, then the recipe is dispensed into a container. The ΔE tolerance for most commercial matches is 1.0, but for certain applications or customers, the ΔE tolerance could be 1.50, 2.00, or possibly even higher. The MI may be either a CIE special index comprised of one or more ΔE values for additional illuminants (A, F2, F11, etc.) or it may preferably be a spectral conformance index based on the differences between the spectral reflectance factor curves of the ink primary and the paint primary, wavelength by wavelength across the visible spectrum. The MI tolerance is generally greater than the AE tolerance, usually about one and a half to two times greater. If the AE and MI tolerance of the color are not met in the initial match, then a correction or series of corrections would be required until the tolerances are met. Preferably, corrections would be carried out using colorant prediction software, but as aforementioned, any known color matching technique could be enlisted. The dispensed inks are then preferably brought to a wide format inkjet printer (such as a Mimaki JVX400LX latex printer) and charged into the print heads. The PDF/X graphic is preferably run through the printer's raster image processor (RIP) and the colors assigned to the appropriate print heads. The image is preferably downloaded into the printer's memory and the printing is started. The printing continues until the number of requested impressions has been completed and then the printing ceases.

After the printing has ceased, the individual print heads are removed and cleaned so that the next color ink may be charged into the head. Alternatively, it may be less expensive to simply replace the print head rather than cleaning the print head. The next set of inks are processed and charged into the print heads and the printing process is repeated. Finished prints may be submitted to a UV lamp station for curing or to a low temperature forced air oven for drying.

Once the prints are dried or cured, they can be stacked and moved to a slitting or stencil cutting machine to separate the groups of color patches into strips. The strips would be gathered and shipped to a warehouse for distribution to the point of sale.

Alternatively, the printing or coatings may be applied directly on to substrates such as card, paper or film which are of the finished dimensions.

It should be noted that printing colors with an inkjet printing head is not restricted to paper, card or plastic film substrates. Inkjet inks are known to be printed directly onto cloth substrates in a process known as textile printing. Traditionally, textile printing has used the methods of pad printing or screen printing where dye-based inks are applied to the cloth and then chemically or thermally “fixed” to the fibers of the cloth. More recently, it has been disclosed that it is possible to use dye-based inkjet inks to produce images on cloth, much like the home inkjet printer which uses dye-based inkjet inks to print on paper substrates. But, unlike the prints from a home inkjet printer, which are not “fast” to exposure to water, solvents and light, leading to bleeding and fading, commercially printed textiles are put through a “fixing” process where the dyes are chemically bound to the fibers of the substrate. The chemical reaction of the dyes with the fibers makes the printed cloth far less susceptible to the impact of environmental processes. In particular, UV-cured inks are known for possessing great stability after curing and so processing the textile printed with UV-cured inks will provide a very durable, colored fabric. Since fabrics are also marketed with the delivery of small swatches of colored fabric, the present invention could be utilized to develop textile or fabric swatches using the very same inventive process. Prior art for the production of textile swatches normally involves dipping or vat dyeing of small lots of fabric which is then fixed with a steam process. Again, the swatches would be cut from a larger piece of cloth and mounted to printed card stock carriers or the identification could be printed by the inkjet directly onto the textile substrate. The present invention would allow the manufacture of multiple swatches, labeled and mounted in a single continuous step, greatly speeding up the process and reducing the waste normally experienced in vat dyeing.

Finally, it will be noted that UV-cured inks are routinely printed onto plastic films used in the production of consumer packaging, generally food packaging. The prints are known to be durable and capable of producing a large gamut of custom color. The production of colored engineering plastics requires the development of chips and guides showing the range of color that can be produced in a given plastic. It is very time consuming and expensive to charge an injection molding machine to produce these plastic chip “swatches”. Because the current invention allows the inkjet to be spectrally matched to the color of the process primary, it is possible to produce blends of the inkjet inks that will simulate closely the spectral reflectance and hence the colors of compounded plastics, including the impact of the temperature of the extruder on the pigments. Many pigments become partially solubilized by the high temperature of the extrusion process. So simply matching the chemistry of the pigmentation is not sufficient to produce a close spectral match. What is required is that the inkjet inks will match the colors of the dispersed pigments after being processed and melted by the molding process. Plastic chips that exemplify the range of colors available could be created, labeled and die-cut to size in a single process step saving many hours of processing through a compounding machine, an extrusion and molding machine, a drilling and cutting machine, moving the plastic in bulk from one machine to the next.

The invention is further described by the examples given below.

### Examples

### Example 1: Spot Color Match to Pantone®GOE System® Reference Colors

### Digital Base Color Assortment Library:

To create a digital base color assortment library, using a set of base inks, that could be used by IFS technology to predict custom ink formulations, five standard inks were serially diluted into a series of custom ink cartridges. The series of inks was printed over unprinted (white) and printed (black) areas of inkjet receptive paper. The spectral signature of each print was measured using a portable spectrophotometer (SpectroEye). The following CIE color values were measured:
i. L*=lightness value
ii. a*=red/green value, where positive values indicate amounts of red, and negative values indicate amounts of green
iii. b*=yellow/blue value, where positive values indicate amounts of yellow, and negative values indicate amounts of blue

The spectral values of each printed ink were digitally stored in a base color assortment library.

### Ink Formulation:

Five Pantone®GOE System® colors were chosen for spot color matching. Using IFS technology, custom ink formulations were developed from the base color assortment library with spectral signatures to match each of the reference colors, wherein the tolerance/color difference (AE) of the spot color print and the reference color was less than 2.0 color space units, and preferably less than 1.0 color space unit.

ΔE was calculated using the following equation:

ΔE=[ΔL*²+Δa*²+Δb*²]^{1/2} iv.
v. wherein,
vi. ΔL*=lightness value difference between experimental color print and reference color
vii. Δa*=red/green value difference between experimental color print and reference color
viii. Δb*=yellow/blue value difference between experimental color print and reference color

Results:

By matching the spectral signatures of the inkjet ink base colors to the spectral signatures of the universal dispersions used to create the Pantone reference colors, it was possible to formulate inkjet inks wherein the color difference of the spot color print of the experimental ink and the Pantone reference color was less than 2.0 CMC units, and preferably less than 1.0 CMC unit. Table 1 shows the color difference calculation for each experimental inkjet ink and its respective Pantone reference color.

TABLE 1
Spectral Comparison of Experimental Inks
and Pantone Reference Colors

| | Pantone ® Reference | |
|---|---|---|
| Experimental Ink | Color | ΔE |
| 1 | GOE 9-1-1 | 0.92 |
| 2 | GOE 126-1-1 | 0.71 |
| 3 | GOE 49-1-1 | 1.59 |
| 4 | GOE 93-1-1 | 0.50 |
| 5 | GOE 164-2-2 | 0.92 |

### Example 2. Coating Custom Color Inks with Texturing Compositions

Red, blue and green Epson UltraChrome® HDR Inks were printed on a FlexoProof glossy opaque white proofing film, supplied by EFI, with an Epson Stylus® Pro 7800 wide format inkjet proofer to yield several color blocks on the proofing film approximately 3 inches×2 inches in size. These are termed samples R′, B′ and G′. It is to be appreciated that, in this and all subsequent examples, the red, blue and green colors selected could be substituted by any other colored ink jet ink, including, but not limited to, an ink corresponding to a particular Pantone® shade or matched thereto as shown in example 1.

Each color block was then overcoated with a varnish, the compositions of which are shown in Table 2. Coating of the color blocks was accomplished with a single pass of a Harper QD™ flexo hand proofer using a high volume anilox (9.0 BCM), to generate overcoated glossy (G) and matt (M) samples. The samples were air-dried.

TABLE 2
Overcoat varnish formulations and colored block
samples generated therefrom.

| Varnish | Type | Samples generated |
|---|---|---|
| Advantage OVP V095 | Gloss | R′G; B′G; G′G |
| (obtainable from Sun | | |
| Chemical Corporation) | | |
| PMRPP059V271 Matte OPV | Matt | R′M; B′M; G′M |
| (obtainable from Sun | | |
| Chemical Corporation | | |

### Example 3: Texturing Composition Layers with Custom Colored Ink Layers Printed Thereon

Primer formulations were prepared by mixing the ingredients at ambient temperature as shown in Table 3. FlexoProof glossy opaque white proofing film was coated with a primer as shown in Table 3, with a Harper QD™ flexo hand proofer using a high volume anilox (9.0 BCM). The textured/glassy primer was coated with a single pass; the textured/hydrophobic primer with three passes of the proofer. Then, after air drying the primed film, colored sample blocks were prepared, using, red, blue and green Epson UltraChrome® HDR Inks were printed on the primed films with an Epson Stylus® Pro 7800 wide format inkjet proofer to yield several color blocks on the proofing film approximately 3 inches×2 inches in size. These are termed samples R*, B* and G*

TABLE 3
Primer formulations and colored block samples generated therefrom.

| Primer formulation | | Type | Samples generated |
|---|---|---|---|
| 1) | K188 WB Flexo | Textured/hydrophobic | R*TH; B*TH; G*TH |
| | varnish (97% by | | |
| | weight; obtainable | | |
| | from Shamrock | | |
| | Technologies) | | |
| 2) | 5378W High MW | | |
| | PE wax | | |
| | (3% by weight; | | |
| | obtainable from | | |
| | Shamrock | | |
| | Technologies) | | |
| 1) | K188 WB Flexo | Textured/glassy | R*TG; B*TG; G*TG |
| | varnish (60% by | | |
| | weight; obtainable | | |
| | from Sun Chemical | | |
| | Corporation) | | |
| 2) | +28% Miraval 5311 | | |
| | Silver-White Effect | | |
| | pigment (28% by | | |
| | weight; from EMD) | | |
| 3) | Water (12% by | | |
| | weight) | | |

### Example 4: Surface Profiles of the Textured Custom Colored Swatches of Examples 2 and 3

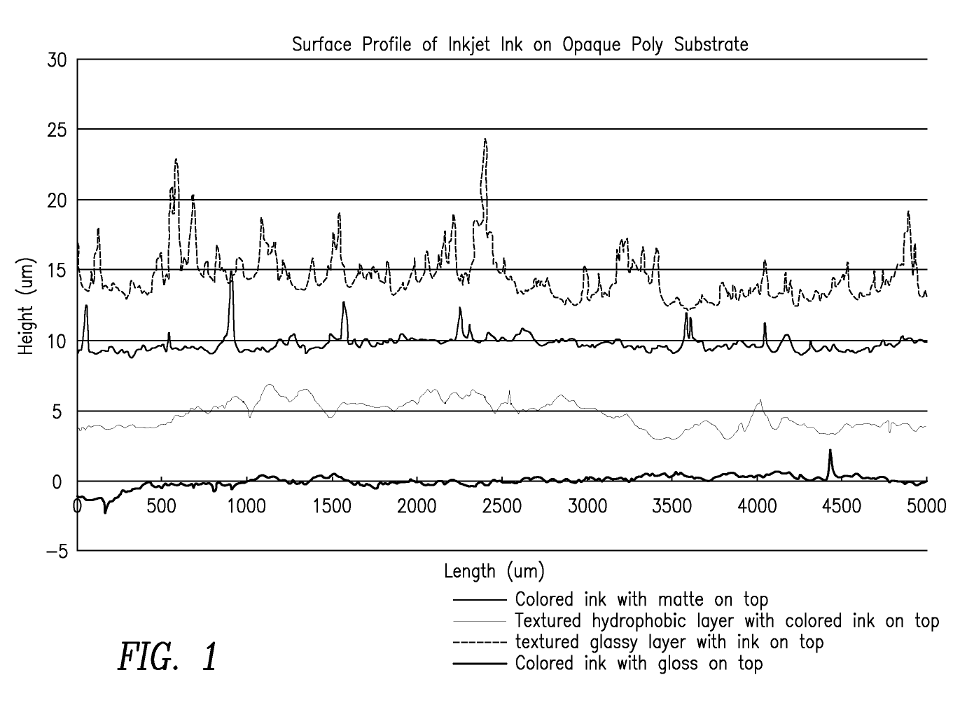

Representative samples from each of the two overcoated and each of the two primed color blocks were measured using a Dektak 150 Surface Profiler to obtain for their surface texture. The results are shown in FIG. 1.

The results show that color blocks of different degrees of roughness, which equates to the textural look and feel of the color blocks, can be obtained by appropriate selection of primer and/or overcoat type.

### Example 5: Visual Inspection of Textured Custom Color Swatches

Red, blue and green Epson UltraChrome® HDR Inks were printed on FlexoProof glossy opaque white proofing film with an Epson Stylus® Pro 7800 wide format inkjet proofer to yield several color blocks on the proofing film approximately 3 inches×2 inches in size. These are termed samples R, B and G.

Visual inspection of the reference blocks against the four types of color block generated in Examples 2 and 3 reveal additional variation between each of them. Blocks R′G, B′G, and G′G show high gloss, in comparison to all other samples. Blocks R′M, B′M and G′M showed a more opaque, flat finish compared to the glossy and reference samples. Blocks R*TG, B*BG and G*TG showed a high degree of mattness compared to the reference samples but also a clear sparkle effect when compared to the matt samples R′M, B′M and G′M. Blocks R*TH, B*TH and G′TH showed a pleasing marbled effect in comparison to all other samples, which were of uniform visual appearance.

While the present invention has been described with reference to the specific embodiments thereof, it should be understood by those skilled in the art that various changes may be made, and equivalents may be substituted, without departing from the true spirit and scope of the invention. In addition, many modifications may be made to adapt a particular situation, material, composition of matter, process, process step or steps, to the objective, spirit and scope of the present invention. All such modifications are intended to be within the scope of the invention.

1. A method for producing a textured custom color swatch comprising printing or coating at least one custom color ink layer and at least one texturing composition layer onto a substrate.

2. The method according to claim 1 comprising printing a custom color ink layer onto the substrate and printing or coating a texturing composition layer onto the printed custom color ink layer, and optionally followed by printing a further custom color ink layer onto the printed or coated texturing composition layer.

3. The method according to claim 1 comprising printing or coating a texturing composition layer onto the substrate and printing a custom color ink layer onto the printed or coated texturing composition layer, and optionally followed by printing or coating a further texturing composition layer onto printed the custom color ink layer.

4) (canceled)

5) (canceled)

6. The method according to claim 1, wherein the ink layers and/or the textured composition layers are optionally cured prior to the subsequent layer being printed or coated thereon.

7. The method according to claim 1, wherein the custom colored ink is an inkjet ink and/or wherein the texturing composition comprises a texturing additive.

8. (canceled)

9. The method according to claim 7, wherein the texturing additive is polyethylene wax or wherein the texturing additive is an inorganic pigment.

10. (canceled)

11. The method according to claim 1, wherein the custom color ink layer is digitally printed onto the substrate or the texturing composition layer.

12. The method according to claim 11 comprising:
a) producing a custom color ink that is a spectral match to a desired color by blending inkjet base inks with transparent, translucent or opaque white bases to produce colors; and
b) printing the custom color ink onto the substrate or the texturing composition layer with an inkjet printer to produce a custom color ink layer.

13. The method according to claim 11 wherein the custom color ink depicts (i) a paint color, (ii) a textile color or (iii) a plastic color.

14. (canceled)

15) (canceled)

16. The method according to claim 13 wherein the paint color is part of a paint color selection guide wherein the textile color is part of a textile color selection guide and wherein the plastic color is part of a plastic color selection guide.

17) (canceled)

18) (canceled)

19. The method according to claim 11 wherein the custom color ink is produced using a computer assisted colorant recipe prediction system optimized for matching ink colors and containing a library of base inks whose colors are spectral matches to the universal colorant dispersions used to produce said color when mixed with transparent white bases.

20. The method according to claim 12 wherein the inkjet printer is a wide format inkjet printer.

21. The method according to claim 12 wherein the base inks are kept in a container interfaced to a computer capable of digitally dispensing the base ink into a container or package, the method comprising mixing a combination of dispensed base inks and charging the mixed combination of base inks into a printing head for a digital printer.

22. The method according to claim 11, wherein the digital printing is carried out by any one of the following: (i) a digital UV printer that incorporates either UV LED sources or UV arc lamp sources to provide energy for curing the UV inks; (ii) a digital printer that uses water-borne or latex inks and that incorporates a heating and drying station to dry the water-borne inks; (iii) a digital printer that is a solvent-based printer that incorporates a heating and drying station to dry the solvent-based inks; (iv) a digital printer that incorporates hot melt wax inkjet inks; or (v) a digital printer incorporating thermal transfer printing.

23) (canceled)

24) (canceled)

25) (canceled)

26) (canceled)

27. The method according to claim 12, wherein the digital printing with the inkjet printer is a continuous inkjet printing method or a drop-on-demand inkjet printing method.

28) (canceled)

29. The method according to claim 1, wherein the texturing composition layer is printed or coated in the form of a pattern to provide a raised or a contrasting surface and/or wherein a texturing composition layer is printed or coated onto an uncured custom color ink layer and interacts with the custom color layer to create a textured effect on the substrate and/or wherein portions of the texturing composition layer are removed to provide a texturing effect.

30. The method according to claim 29 wherein the texturing composition layer provides a textured effect selected from the group consisting of rough, grooved, suede, cement, leather, satin, woven, wood-grain, Braille, marbled, embossed and hammer-finish.

31) (canceled)

32) (canceled)

33) (canceled)

34. The method according to claim 1, wherein texture for the textured custom colored swatch is selected either by scanning an existing texture and using the digital data set corresponding to that scan to reproduce the texture onto the substrate or the custom color ink layer or by selecting a texture from a preformed data set held in a computer.

35. The method according to claim 1, wherein the at least one custom color ink layer and/or at least one texturing composition layer is printed or coated on both sides of the substrate.

36. The method according to claim 1, wherein the substrate is a card, textile or a chip.

37. The textured custom color swatch prepared by the method of claim 1 and optionally wherein the swatch is a card, palette or a display.

38) (canceled)
